(19) United States
(12) Patent Application Publication
(10) Pub. No.: US 2015/0130909 A1
(43) Pub. Date: May 14, 2015

(54) METHOD AND ELECTRICAL DEVICE FOR TAKING THREE-DIMENSIONAL (3D) IMAGE AND NON-TRANSITORY COMPUTER-READABLE STORAGE MEDIUM FOR STORING THE METHOD

(71) Applicant: Institute for Information Industry, Taipei (TW)

(72) Inventors: Jia-Huang Tang, New Taipei City (TW); Ruen-Rone Lee, Hsinchu City (TW); Chih-Chun Wang, Taoyuan County (TW)

(73) Assignee: Institute for Information Industry, Taipei (TW)

(21) Appl. No.: 14/185,109

(22) Filed: Feb. 20, 2014

(30) Foreign Application Priority Data
Nov. 11, 2013 (TW) 102140912

(51) Int. Cl. H04N 13/02; G06T 7/00

(52) U.S. Cl. CPC H04N 13/0207; G06T 7/0075; G06T 2207/10021
USPC 348/50

(57) ABSTRACT

In a method for taking three-dimensional (3D) images, a camera unit of an electrical device is utilized to shoot a same scene with a same lens focal length and focusing on different distances respectively to generate several pictures. Depth-map information of several blocks on the scene is calculated according to levels of clarity on the blocks. Offsets of the blocks of the pictures are respectively adjusted for right and left eyes according to the depth-map information of the blocks to generate at least one 3D image. The present invention also discloses an electrical device for taking 3D images and a non-transitory computer-readable storage medium for storing the method for taking a 3D image.

### RELATED APPLICATIONS

This application claims priority to Taiwan Application Serial Number 102140912, filed Nov. 11, 2013, which is herein incorporated by reference.

### BACKGROUND

1. Field of Invention

The present invention relates to a method and an electrical device for taking three-dimensional (3D) images and a non-transitory computer-readable storage medium for storing the method. More particularly, the present invention relates to a method and an electrical device for taking 3D images utilizing a single camera unit and a non-transitory computer-readable storage medium for storing the method.

2. Description of Related Art

As computer technology progresses, many applications are digitalized. In photography domains, lots of digital image-formats are developed. Image sensors are utilized for shooting digital images. Conventional two dimensions (2D) cameras are mainstreams in the visual-image application. However, along with the development of three dimensions (3D) displays, there is a need for cameras to take 3D images.

In the prior arts, 3D images (for example, video or pictures) are produced utilizing two lens and two sensors. Such hardware cost is much more than the cost for a 2D camera, which leads that available 3D image contents are much less than available 2D image contents.

Above all, there is a need to generate 3D image contents without increasing hardware costs.

### SUMMARY

According to one embodiment of this invention, a method for taking three-dimensional (3D) images is provided to shoot several pictures utilizing a single camera unit for generating 3D images. The method for taking 3D images includes the following steps:

(a) A camera unit of an electrical device is utilized to shoot a same scene with a same lens focal length and focusing on different distances respectively to generate several pictures.

(b) Depth-map information of several blocks on the scene is calculated according to levels of clarity on the blocks.

(c) Offsets of the blocks of the pictures are adjusted respectively for right and left eyes according to the depth-map information of the blocks to generate at least one 3D image.

According to another embodiment of this invention, an electrical device for taking 3D images is provided. The electrical device for taking 3D images includes a camera unit, a storage unit and a processing unit. The processing unit is electrically connected with the camera unit and the storage unit. The storage unit stores several instructions. The instructions stored in the storage unit are operable to cause the processing unit to: drive the camera unit to shoot a same scene with a same lens focal length and focusing on different distances respectively to generate several pictures; calculate depth-map information of several blocks on the scene according to levels of clarity on the blocks; and adjust offsets of the blocks of the pictures respectively for right and left eyes according to the depth-map information of the blocks to generate at least one 3D image.

According to another embodiment of this invention, a non-transitory computer-readable storage medium storing a computer program for executing the steps of the aforementioned method for taking 3D images is provided. Steps of the method are as disclosed above.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow diagram of a method for taking three-dimensional (3D) images according to one embodiment of this invention;

FIG. 2 illustrates an embodiment of a scene for a camera unit of an electrical device to shoot;

FIG. 3 illustrates an embodiment to adjust offsets of the blocks respectively for right and left eyes according to the depth-map information of the blocks to generate at least one 3D image;

FIG. 4 illustrates an embodiment to adjust offsets of the blocks respectively for right and left eyes according to the depth-map information of the blocks to generate at least one 3D image; and

FIG. 5 illustrates a block diagram of an electrical device for taking 3D images according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

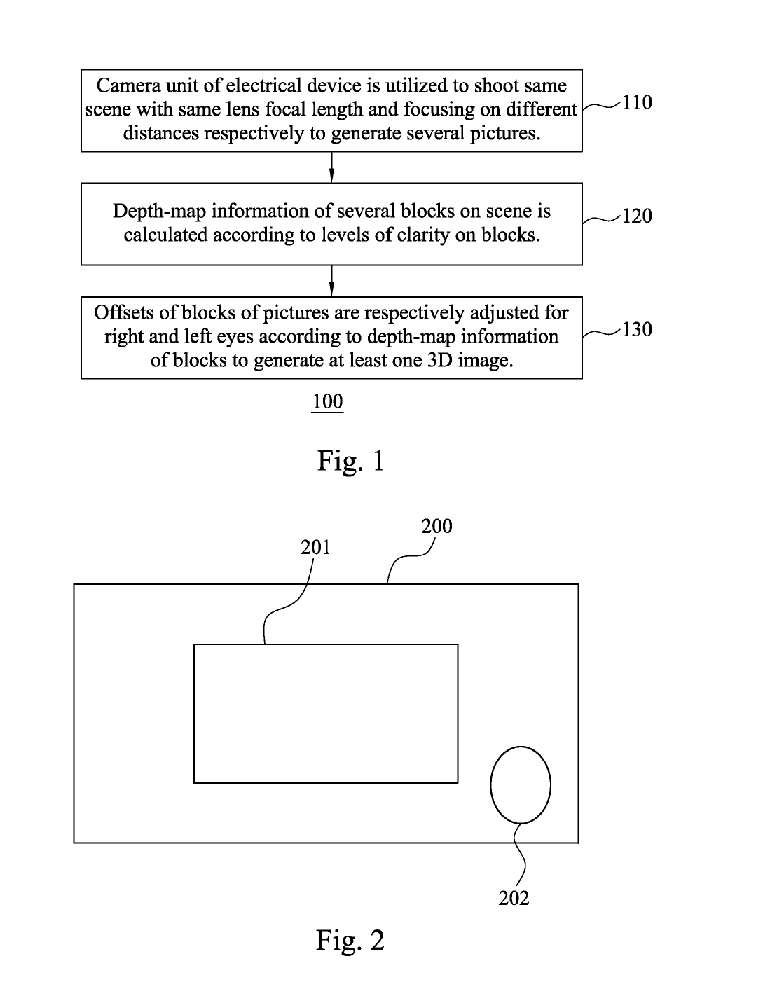

Referring to FIG. 1, a flow diagram will be described that illustrates a method for taking three-dimensional (3D) images according to one embodiment of this invention. In the method for taking 3D images, a single camera unit is utilized to shoot several pictures for generating 3D images. The method for taking 3D images may take the form of a computer program product (for example, an APP) stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs), digital versatile disc read only memories (DVD-ROMs), and Blu-ray Disc read only memories (BD-ROMs); magnetic storage devices such as hard disk drives (HDDs); and solid-state disks (SSDs).

The method 100 for taking 3D images includes the following steps:

At step 110, a camera unit of an electrical device is utilized to shoot a same scene with a same lens focal length and focusing on different distances respectively to generate several pictures. For example, the lens focal length of the camera unit may be fixed, and then the camera unit may focus on several different points with different focus distances to shoot the same scene to respectively generate several pictures.

At step 120, depth-map information of several blocks on the scene is calculated according to levels of clarity on the blocks. In some embodiments of this invention, which of the blocks belonging to which of the pictures is the clearest may be determined by comparing the blocks corresponding to the same location among the pictures using the clarity values of the blocks. Then, the distances on which the camera unit focuses for generating the clearest pictures are designated for use as depths for the blocks, and the depths for the blocks are recorded. In other words, for each block on the scene, the clearest picture may be determined and the distance, on which the camera unit focuses for generating the clearest picture, is set as the depth-map information. In addition, each picture may be divided into M×N blocks for determining their depth information block by block.

At step 130, offsets of the blocks of the pictures are respectively adjusted for right and left eyes according to the depth-map information of the blocks to generate at least one 3D image. Therefore, one single camera unit is required for generating at least one 3D image, and, as a result, cost for hardware can be reduced.

Referring to FIG. 2, an embodiment of a scene for the camera unit of the electrical device to shoot is illustrated. In this embodiment, the lens of the camera unit is fixed at a preset lens focal length (for example, 50 mm or any other available lens focal length), and the camera unit focuses on several different distances to shoot the same scene 200 to respectively generate several pictures (step 110). For instance, the camera unit focuses on 1 m to shoot the scene 200 to generate one picture, and the camera unit focuses on 5 m to shoot the scene 200 to generate another picture.

Then, depth-map information of several blocks on the scene is calculated according to the levels of clarity on the blocks of the pictures focused on 1 m and 5 m. For example, if an object 201 on one block of the picture focused on 1 m is clearer than that focused on 5 m, the depth-map information of the block including the object 201 is set to 1 m in depth; if an object 202 on one block of the picture focused on 5 m is clearer than that focused on 1 m, the depth-map information of the block including the object 202 is set to 5 m in depth.

Hence, offsets of the blocks including the objects 201, 202 of the pictures are adjusted respectively for right and left eyes according to the depth-map information of the blocks to generate at least one 3D image (step 130).

In one embodiment of step 120, a clarity value of each of the blocks respectively on the pictures can be calculated. For example, for the block having the object 201, the clarity values on the pictures focused on 1 m and 5 m are calculated respectively. Similarly, for the block having the object 202, the clarity values on the pictures focused on 1 m and 5 m are calculated respectively. An energy value of each block, a differential value of pixels on each block, an image gradient of each block or any other value for representing a level of clarity of each block can be taken as the clarity value of each block. Which of the blocks belonging to which of the pictures is the clearest may be determined by comparing the blocks corresponding to the same location among the pictures using the clarity values of the blocks. Then, the distances on which the camera unit focuses for generating the clearest pictures is designated for use as depths for the blocks, and the depths for the blocks are recorded.

In some embodiments of step 120, a domain transform algorithm may be utilized to transform pixel values on the blocks of the pictures into several energy values. The energy values are taken as the clarity values of the blocks on the pictures respectively. The domain transform algorithm may be Discrete Fourier Transform algorithm or any other domain transform algorithm. The higher the energy values (especially for the energy values on high frequencies) are, the clearer the blocks on the pictures are. Hence, the distances on which the camera unit focuses for generating the clearest pictures (the pictures with the highest energy values) are designated for use as depths for the blocks, and the depths for the blocks are recorded in the depth-map information of the blocks.

In some other embodiments of step 120, an image-differential-value calculating algorithm is utilized to calculate differential values of pixels respectively on each block on each picture. The differential values are taken as the clarity values of the blocks on the pictures. The differential values of pixels may be the differences between the pixel values on one single block and pixel average, difference between the neighboring pixels or any other method to calculate the differential values. The higher the differential values of pixels are, the clearer the blocks on the pictures are. Hence, the distances on which the camera unit focuses for generating the clearest pictures (the pictures with the highest differential values of pixels) are designated for use as depths for the blocks, and the depths for the blocks are recorded in the depth-map information of the blocks.

In some other embodiments of step 120, pixel values of each block on each picture is transformed into an image gradient. The image gradients are taken as the clarity values of the blocks on the pictures. The image gradients can be calculated utilizing Laplacian operator, Tenengrad function, sobel operator, or any other algorithm to calculate the image gradients. The higher the image gradients are, the clearer the blocks on the pictures are. Hence, the distances on which the camera unit focuses for generating the clearest pictures (the pictures with the highest image gradients) are designated for use as depths for the blocks, and the depths for the blocks are recorded in the depth-map information of the blocks.

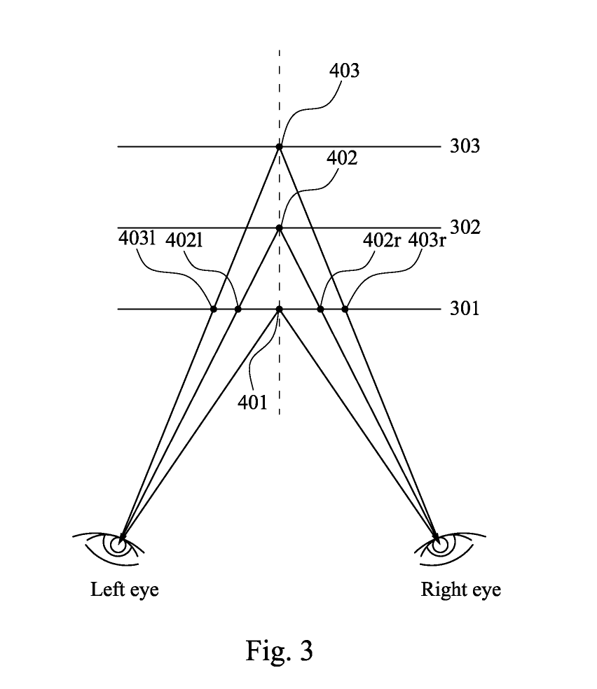

Referring to FIG. 3, an embodiment to adjust offsets of the blocks respectively for right and left eyes according to the depth-map information of the blocks to generate at least one 3D image is illustrated. The original pixels of the picture are on the surface 301. In this embodiment, the 3D image is utilized for being displayed on an Uncrossed-Parallax display unit. Hence, offsets of the pixel on the block 401 for left and right eyes are adjusted according to the depth of the block 401. For example, if the depth of the pixel of the block 401 is on the layer 302, the pixel on the block 401 of the 3D image for the left eye is adjusted to the location 4021, and the pixel on the block 401 of the 3D image for the right eye is adjusted to the location 402r. Therefore, the Uncrossed-Parallax display unit can display the pixel on the block 401 as if on the location 402 of the layer 302.

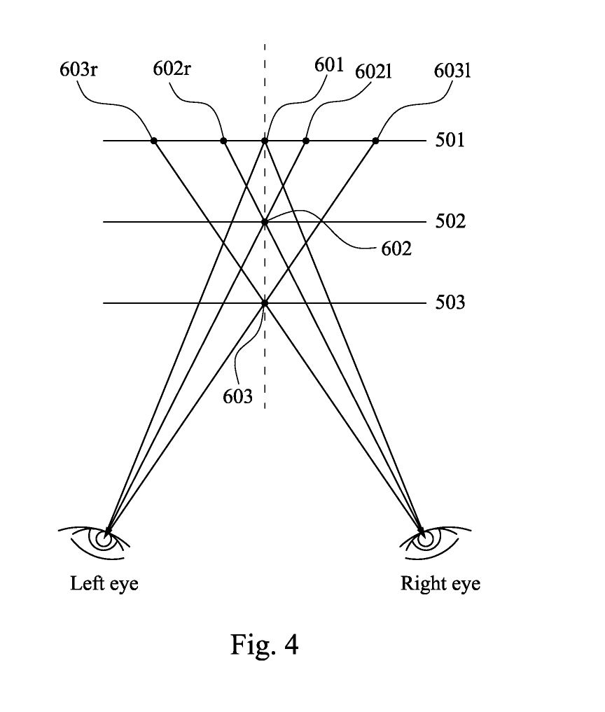

Referring to FIG. 4, an embodiment to adjust offsets of the blocks respectively for right and left eyes according to the depth-map information of the blocks to generate at least one 3D image is illustrated. The original pixels of the picture are on the surface 501. In this embodiment, the 3D image is utilized for being displayed on a Crossed-Parallax display unit. Hence, offsets of the pixel on the block 601 for left and right eyes are adjusted according to the depth of the block 601. For example, if the depth of the pixel of the block 601 is on the layer 503, the pixel on the block 601 of the 3D image for the left eye is adjusted to the location 6031, and the pixel on the block 601 of the 3D image for the right eye is adjusted to the location 603r. Therefore, the Crossed-Parallax display unit can display the pixel on the block 601 as if on the location 603 of the layer 503.

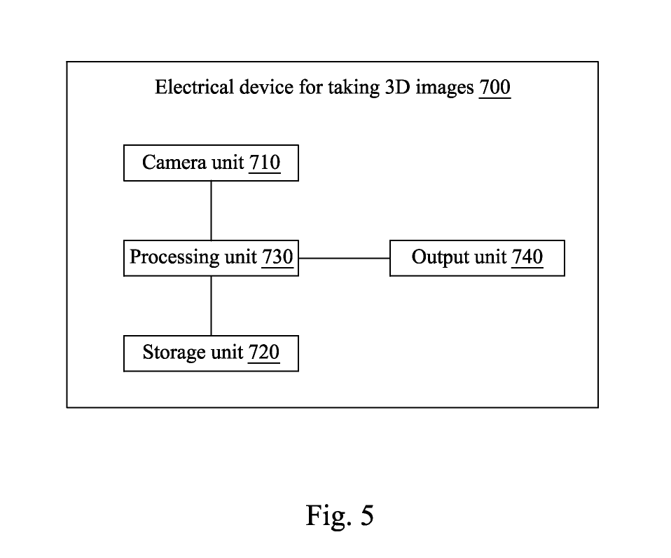

Referring to FIG. 5, a block diagram of an electrical device for taking 3D images according to one embodiment of this invention is illustrated. The electrical device 700 for taking 3D images includes a camera unit 710, a storage unit 720 and a processing unit 730. The processing unit 730 is electrically connected with the camera unit 710 and the storage unit 720. The storage unit stores several instructions.

The camera unit 710 may include a single lens and a single sensor. The storage unit 720 may be a read-only memory (ROM), a flash memory, a soft disk drive (S.D.D.), a hard disk drive (H.D.D.), an optical storage device, an USB disk, a database accessible from a network, or any other storage unit. The processing unit 730 may be a central processing unit (CPU), a control unit, a micro-processor or any other hardware for executing instructions.

The storage unit 720 stores several instructions for the processing unit 730 to access to provide functions of the electrical device 700 for taking 3D images. The steps in the present invention can be implemented as instruction codes for being stored in the storage unit 720. The processing unit 730 accesses the instruction codes in the storage unit 720 to provide corresponding functions.

The instructions stored in the storage unit 720 are operable to cause the processing unit 730 to drive the camera unit to shoot a same scene with a same lens focal length and focusing on different distances respectively to generate several pictures. The processing unit 730 may fix the lens focal length of the camera unit 720, and then the processing unit 730 drives the camera unit 710 to focus on several different points with different focus distances to shoot the same scene to respectively generate several pictures.

The processing unit 730 calculates depth-map information of several blocks on the scene according to levels of clarity on the blocks. In some embodiments of this invention, the processing unit 730 may determine which of the blocks belonging to which of the pictures is the clearest by comparing the blocks corresponding to the same location among the pictures using the clarity values of the blocks. Then, the processing unit 730 may designate the distances on which the camera unit focuses for generating the clearest pictures for use as depths for the blocks, and may record the depths for the blocks. In other words, for each block on the scene, the processing unit 730 may determine the clearest picture and set the distance, on which the camera unit 710 focuses for generating the clearest picture, as the depth-map information. In addition, the processing unit 730 may divide each picture into M×N blocks for determining their depth information block by block.

The processing unit 730 adjusts offsets of the blocks of the pictures respectively for right and left eyes according to the depth-map information of the blocks to generate at least one 3D image. Therefore, one single camera unit is required for generating at least one 3D image, and, as a result, cost for hardware can be reduced.

In addition, the electrical device 700 for taking 3D images may further include an output unit 740, which is electrically connected with the output unit 740. The output unit 740 is utilized for outputting data utilizing a wired or wireless data transmission protocol. Hence, the processing unit 730 may drive the output unit 740 to output the at least one 3D image to a 3D display unit for display. The 3D display unit may be disposed on the electrical device 700 for taking 3D images or other external electrical device.

In some embodiments of this invention, the processing unit 730 may calculate the depth-map information of the blocks utilizing the following steps: the processing unit may calculate a clarity value of each of the blocks respectively on the pictures. The processing unit 730 may set an energy value of each block, a differential value of pixels on each block, an image gradient of each block or any other value for representing a level of clarity of each block as the clarity value of each block. The processing unit 730 may then determine which of the blocks belonging to which of the pictures is the clearest by comparing the blocks corresponding to the same location among the pictures using the clarity values of the blocks. The processing unit 730 designates the distances on which the camera unit 710 focuses for generating the clearest pictures for use as depths for the blocks, and records the depths for the blocks.

The processing unit 730 may utilize a domain transform algorithm to calculate the clarity value of each block respectively on the pictures. In detail, the processing unit 730 may utilize a domain transform algorithm to transform pixel values on the blocks of the pictures into several energy values. The energy values are taken as the clarity values of the blocks on the pictures respectively. The domain transform algorithm may be Discrete Fourier Transform algorithm or any other domain transform algorithm. The higher the energy values (especially for the energy values on high frequencies) are, the clearer the blocks on the pictures are. Hence, the processing unit 730 may designate the distances on which the camera unit 710 focuses for generating the clearest pictures (the pictures with the highest energy values) for use as depths for the blocks, and may record the depths for the blocks.

In addition, the processing unit 730 may utilize an image-differential-value calculating algorithm to calculate the clarity value of each block respectively on the pictures. In detail, the processing unit 730 may utilize an image-differential-value calculating algorithm to calculate differential values of pixels respectively on each block on each picture. The differential values are taken as the clarity values of the blocks on the pictures. The differential values of pixels may be the differences between the pixel values on one single block and pixel average, difference between the neighboring pixels or any other method to calculate the differential values. The higher the differential values of pixels are, the clearer the blocks on the pictures are. Hence, the processing unit 730 may designate the distances on which the camera unit 710 focuses for generating the clearest pictures (the pictures with the highest differential values of pixels) for use as depths for the blocks, and may record the depths for the blocks.

Moreover, the processing unit 730 may utilize a method for calculating image gradients to calculate the clarity value of each block respectively on the pictures. In detail, the processing unit 730 may transform pixel values of each block on each picture into an image gradient. The image gradients are taken as the clarity values of the blocks on the pictures. The image gradients can be calculated utilizing Laplacian operator, Tenengrad function, sobel operator, or any other algorithm to calculate the image gradients. The higher the image gradients are, the clearer the blocks on the pictures are. Hence, the processing unit 730 may designate the distances on which the camera unit 710 focuses for generating the clearest pictures (the pictures with the highest image gradients) for use as depths for the blocks, and may record the depths for the blocks.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for taking three-dimensional (3D) images, comprising:
(a) utilizing a camera unit of an electrical device to shoot a same scene with a same lens focal length and focusing on different distances respectively to generate a plurality of pictures;
(b) calculating depth-map information of a plurality of blocks on the scene according to levels of clarity on the blocks; and
(c) adjusting offsets of the blocks of the pictures respectively for right and left eyes according to the depth-map information of the blocks to generate at least one 3D image.

2. The method for taking 3D images of claim 1, wherein step (b) comprises:
calculating a clarity value of each of the blocks for each of the pictures;
determining which of the blocks belonging to which of the pictures is the clearest by comparing the blocks corresponding to the same location among the pictures using the clarity values of the blocks; and
designating the distances on which the camera unit focuses for generating the clearest pictures for use as depths for the blocks, and recording the depths for the blocks.

3. The method for taking 3D images of claim 2, wherein the step of calculating the clarity value of each block respectively on the pictures comprising:
utilizing a domain transform algorithm to transform pixel values on the blocks of the pictures into a plurality of energy values, wherein the energy values are taken as the clarity values of the blocks on the pictures,
wherein the higher the energy values are, the clearer the blocks on the pictures are.

4. The method for taking 3D images of claim 2, wherein the step of calculating the clarity value of each block respectively on the pictures comprising:
utilizing an image-differential-value calculating algorithm to calculate differential values of pixels respectively on each block on each picture, wherein the differential values are taken as the clarity values of the blocks on the pictures,
wherein the higher the differential values of pixels are, the clearer the blocks on the pictures are.

5. The method for taking 3D images of claim 2, wherein the step of calculating the clarity value of each block respectively on the pictures comprising:
transforming pixel values of each block on each picture into an image gradient, wherein the image gradients are as the clarity values of the blocks on the pictures,
wherein the higher the image gradients are, the clearer the blocks on the pictures are.

6. An electrical device for taking three-dimensional (3D) images, comprising:
a camera unit;
a storage unit configured to store a plurality of instructions; and
a processing unit electrically connected with the camera unit and the storage unit, wherein the instructions stored in the storage unit are operable to cause the processing unit to:
(a) drive the camera unit to shoot a same scene with a same lens focal length and focusing on different distances respectively to generate a plurality of pictures;
(b) calculate depth-map information of a plurality of blocks on the scene according to levels of clarity on the blocks; and
(c) adjust offsets of the blocks of the pictures respectively for right and left eyes according to the depth-map information of the blocks to generate at least one 3D image.

7. The electrical device for taking 3D images of claim 6, wherein the instructions operable to cause the processing unit to execute step (b) comprises:
calculating a clarity value of each of the blocks for each of the pictures;
determining which of the blocks belonging to which of the pictures is the clearest by comparing the blocks corresponding to the same location among the pictures using the clarity values of the blocks; and
designating the distances on which the camera unit focuses for generating the clearest pictures for use as depths for the blocks, and recording the depths for the blocks.

8. The electrical device for taking 3D images of claim 7, wherein the instructions operable to cause the processing unit to calculate the clarity value of each block respectively on the pictures comprises:
utilizing a domain transform algorithm to transform pixel values on the blocks of the pictures into a plurality of energy values, wherein the energy values are taken as the clarity values of the blocks on the pictures,
wherein the higher the energy values are, the clearer the blocks on the pictures are.

9. The electrical device for taking 3D images of claim 7, wherein the instructions operable to cause the processing unit to calculate a clarity value of each block respectively on the pictures comprises:
utilizing an image-differential-value calculating algorithm to calculate differential values of pixels respectively on each block on each picture, wherein the differential values are taken as the clarity values of the blocks on the pictures,
wherein the higher the differential values of pixels are, the clearer the blocks on the pictures are.

10. The electrical device for taking 3D images of claim 7, wherein the instructions operable to cause the processing unit to calculate the clarity value of each block respectively on the pictures comprises:
transforming pixel values of each block on each picture into an image gradient, wherein the image gradients are taken as the clarity values of the blocks on the pictures,
wherein the higher the image gradients are, the clearer the blocks on the pictures are.

11. The electrical device for taking 3D images of claim 6, further comprising
an output unit electrically connected with the processing unit, wherein the processing unit drives the output unit to output the at least one 3D image to a 3D display unit for display.

12. A non-transitory computer-readable storage medium that stores a program which causes a computer to execute a method for taking three-dimensional (3D) images, wherein the method for taking 3D images comprises:
(a) utilizing a camera unit of an electrical device to shoot a same scene with a same lens focal length and focusing on different distances respectively to generate a plurality of pictures;
(b) calculating depth-map information of a plurality of blocks on the scene according to levels of clarity on the blocks; and
(c) adjusting offsets of the blocks of the pictures respectively for right and left eyes according to the depth-map information of the blocks to generate at least one 3D image.
